(19) United States
(12) Patent Application Publication
(10) Pub. No.: US 2026/0194018 A1
(43) Pub. Date: Jul. 9, 2026

(54) CONTROL METHOD AND CONTROL DEVICE FOR A HYBRID TURBINE ENGINE

(71) Applicant: SAFRAN AIRCRAFT ENGINES, Paris (FR)

(72) Inventors: Seif Eddine BENATTIA, MOISSY-CRAMAYEL (FR); Rudy Charles André AULNETTE, MOISSY-CRAMAYEL (FR); Christophe LABBE, MOISSY-CRAMAYEL (FR)

(73) Assignee: SAFRAN AIRCRAFT ENGINES, Paris (FR)

(21) Appl. No.: 19/133,848

(22) PCT Filed: Nov. 27, 2023
(86) PCT No.: PCT/FR2023/051857

§ 371 Date: Jun. 26, 2025

(30) Foreign Application Priority Data
Nov. 30, 2022 (FR) FR2212567

(51) Int. Cl. F02C 9/28; B64D 27/33; B64D 31/18

(52) U.S. Cl. CPC F02C 9/28; B64D 27/33; B64D 31/18

(57) ABSTRACT

A method for controlling a hybrid turbomachine includes determining a sequence of deviations, each being a difference between a measurement of a sequence of measurements of a speed of a low-pressure shaft of the hybrid turbomachine and a setpoint of a sequence of setpoints of the speed of the low-pressure shaft, determining a variation of fuel flow rate and determining a variation of electrical torque, the electrical torque being configured to be applied to the low-pressure shaft, and controlling the hybrid turbomachine in order to vary a fuel flow rate according to the determined variation of fuel flow rate and in order to vary an electrical torque according to the determined variation of electrical torque.

### FIELD OF THE INVENTION

The invention relates to the control of a hybrid turbomachine, i.e. a turbomachine having a thermal drive and an electric drive.

The invention relates, in particular, to a control method and a control device which are multivariable, i.e. taking into account several degrees of freedom of the controlled system.

### PRIOR ART

A hybrid turbomachine has two degrees of freedom, namely a flow rate of the fuel sent to the combustion chamber and an electrical torque applied to a drive shaft of the turbomachine. Consequently, a hybrid turbomachine is considered as a multivariable system.

The fuel flow rate sent to the combustion chamber and the electrical torque applied to a drive shaft of the turbomachine are “inputs” of the system of the turbomachine. Each acts on the engine speed, i.e. an angular velocity of the drive shaft which is an “output” of the system of the turbomachine.

The two inputs of the system, which are the flow rate of fuel sent to the combustion chamber and the electrical torque applied to a drive shaft of the turbomachine, must be regulated: its value must be fixed, automatically and in real time, to ensure the proper operation of the turbomachine, i.e. to obtain satisfactory output quantities.

The proper operation of the turbomachine can, in particular, be characterized by the proper tracking of a setpoint curve by the output quantity of the turbomachine.

A setpoint curve of an output quantity, for example of the engine speed, is a continuous curve or a time-domain sequence of setpoint values representing the variation over time of such an output quantity, i.e. here the speed of the drive shaft. The closer the actual engine speed to this setpoint curve, the better the operation of the turbomachine.

One method for controlling the turbomachine is the regulation of the input quantities of the system of the turbomachine based on at least one output quantity of the system of the turbomachine. For this one must possess not only a setpoint curve of the output quantity but also a real-time measurement of the output quantity.

The methods for controlling a hybrid turbomachine described previously are not satisfactory since they may require an additional output quantity, such as for example the fuel-load enrichment rate. This presupposes that one possesses not only a setpoint curve but also a real-time measurement of this additional quantity. However, these two items can be difficult to determine or implement, particularly the enrichment rate.

The methods for controlling a hybrid turbomachine described previously are also not satisfactory since they may regulate one input quantity as a function of the other, for example the determination of the electrical torque may be done after and as a function of the determination of the fuel flow rate. In particular the electrical torque may be kept at zero as long as the fuel flow rate can be increased. The two degrees of freedom of the turbomachine are then not used independently and optimally.

There is therefore a need for a method for controlling a hybrid turbomachine that makes it possible to independently use the two degrees of freedom without resorting to output quantities, the setpoint curve or real-time measurement of which is difficult to determine or implement.

### SUMMARY OF THE INVENTION

One aim of the invention is to make provision for a method for controlling a hybrid turbomachine making it possible to independently use two degrees of freedom without resorting to output quantities, a setpoint curve or real-time measurement of which is difficult to determine or implement.

The aim is achieved in the context of the invention owing to a method for controlling a hybrid turbomachine comprising the following steps:
the determination of a sequence of deviations, each deviation being a difference between
   a measurement of a sequence of measurements of a speed of a low-pressure shaft of the hybrid turbomachine and
   a setpoint of a sequence of setpoints of the speed of the low-pressure shaft,
the determination of a variation of a fuel flow rate and the determination of a variation of an electrical torque, the electrical torque being configured to be applied to the low-pressure shaft, the determinations being in particular simultaneous, and the determinations each using:
   a difference in high-pressure speed between a last measurement and a penultimate measurement of a sequence of measurements of a speed of a high-pressure shaft of the hybrid turbomachine,
   a difference in low-pressure speed between a last measurement and a penultimate measurement of the sequence of measurements of the speed of the low-pressure shaft,
   a last deviation associated with the last measurement of the speed of the low-pressure shaft, and
   a sum of the deviations of the sequence of deviations; and the control of the hybrid turbomachine to vary a fuel flow rate by the determined variation in fuel flow rate and an electrical torque by the determined variation in electrical torque.

Such a method is advantageously and optionally completed by the following different features taken alone or in combination:
during the determination of the variation in fuel flow rate and of the variation in electrical torque, a product is determined of a gain matrix and a vector, the vector being formed of the difference in high-pressure speed, the difference in low-pressure speed, the last deviation and the sum of the deviations; and
the gain matrix is obtained by interpolation between two reference matrices of a set of reference matrices such as to take into account an operating point of the hybrid turbomachine associated with the last measurement.

The invention also relates to a device for controlling a hybrid turbomachine comprising:
an input, configured to receive a sequence of measurements of the speed of a low-pressure shaft of the hybrid turbomachine and a sequence of measurements of the speed of a high-pressure shaft of the hybrid turbomachine,
a memory, configured to record the sequence of measurements of the speed of a low-pressure shaft, the sequence of measurements of the speed of a high-pressure shaft and a sequence of setpoints of the speed of the low-pressure shaft,
an electronic control unit, configured to:
   determine a sequence of deviations, each deviation being a difference between
      a measurement of the sequence of measurements of the speed of the low-pressure shaft, and
      a setpoint of the sequence of setpoints of the speed of the low-pressure shaft,
   determine, in particular simultaneously, a variation in fuel flow rate and a variation in an electrical torque, the electrical torque being configured to be applied to the low-pressure shaft, the determinations each using
      a difference in high-pressure speed between a last measurement and a penultimate measurement of the sequence of measurements of the speed of the high-pressure shaft,
      a difference in low-pressure speed between a last measurement and a penultimate measurement of a sequence of measurements of the speed of the low-pressure shaft,
      a last deviation associated with the last measurement of the speed of the low-pressure shaft, and
      a sum of the deviations of the sequence of deviations; and
an output configured to supply a command to the hybrid turbomachine.

The invention also relates to a turbomachine comprising such a device and an aircraft comprising such a turbomachine.

### DESCRIPTION OF THE FIGURES

Other features and advantages of the invention will become further apparent from the following description, which is purely illustrative and non-limiting, and must be read with reference to the appended drawings wherein:

FIG. 1 is a schematic representation of a control device according to an embodiment of the invention; and

FIG. 2 is a schematic representation of an acceleration tracking control according to an embodiment of the invention.

### DETAILED DESCRIPTION OF THE INVENTION

### Hybrid Turbomachine

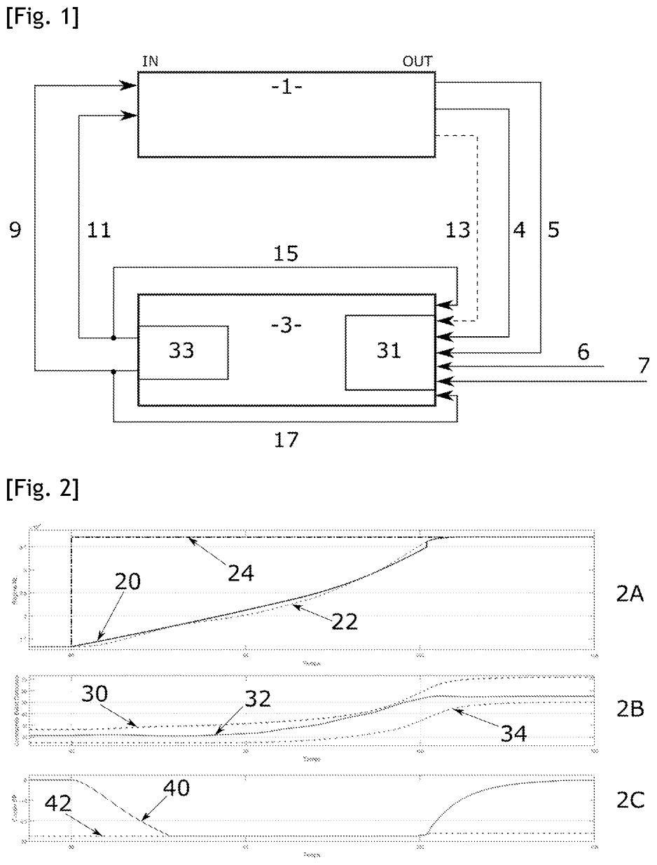

FIG. 1 is a schematic representation of a control device according to an embodiment of the invention on which a hybrid turbomachine 1 comprises a high-pressure driveshaft and a low-pressure drive shaft. The low-pressure drive shaft is set in motion by a thermal drive and an electrical drive.

The thermal drive also acts on the high-pressure drive shaft. The high-pressure drive shaft can also be set in motion by a dedicated electrical drive.

The invention pertains to the hybrid control of the low-pressure shaft.

The low-pressure shaft can be considered, from the point of view of the control, as a multivariable system comprising two control or input quantities:
a fuel flow rate command, “WF”, with the reference number 9 on FIG. 1, sent to a local loop of a fuel meter of the hybrid turbomachine 1,
an electrical torque command “TRQ”, with the reference number 11 on FIG. 1, to be applied by an electric machine to the low-pressure shaft.

More generally, the hybrid turbomachine 1 has several output quantities that must be regulated and/or limited such as in particular a speed of the high-pressure drive shaft, optionally a combustion chamber input pressure.

### Control Device

A control device 3 able to control the high-pressure shaft is shown on FIG. 1.

The operation of the high-pressure shaft is regulated using input quantities, shown on FIG. 1 arriving in the hybrid turbomachine 1 on the “IN” side, and output quantities, shown on FIG. 1 leaving the hybrid turbomachine 1 on the “OUT” side.

The input quantities used are a fuel flow rate and an electrical torque. More precisely, the control device 3 supplies to the hybrid turbomachine 1 the fuel flow rate command 9 to be sent to the combustion chamber and the electrical torque command 11 to be applied by the electric machine to the low-pressure shaft. The output quantities used are the engine speed of the high-pressure shaft and the engine speed of the low-pressure shaft.

A measurement of the speed of the high-pressure shaft 4 and a measurement of the speed of the low-pressure shaft 5 are sent to the control device 3. The measurement of the speed of the high-pressure shaft 4 and the measurement of the speed of the low-pressure shaft 5 presuppose the possession, in the hybrid turbomachine 1, of a sensor of the speed of the high-pressure shaft and a sensor of the speed of the low-pressure shaft.

The control device 3 can also receive a speed setpoint of the low-pressure shaft 7.

A setpoint is a continuous curve or a time-domain sequence of values representing a variation over time of an output quantity, such as for example a desired variation over time of an output quantity, such as for example a desired variation over time of the speed of the low-pressure shaft, namely an angular velocity of the low-pressure shaft. In particular, the setpoint can be associated with a particular maneuver such as a takeoff, a landing, etc.

The control device 3 can also receive a measurement of the external pressure 6. Based on the measurement of the speed of the high-pressure shaft 4, on the measurement of the speed of the low-pressure shaft 5 and on the measurement of the external pressure 6 received, the control device 3 can construct an indicator, for example a transient detection indicator indicating an operating speed in which the engine parameters vary significantly (takeoff, maneuver, crossing of air pockets, landing etc.), a fuel flow rate limit indicator or fuel saturation indicator indicating that this flow rate can no longer be increased or else an electrical torque limit indicator or electrical saturation indicator indicating that the electrical torque can no longer be increased.

The control device 3 can also be looped. For this purpose, the control device 3 can receive, as input,
the fuel flow rate command 9, along a fuel return line 17, and/or
the electrical torque command 11, along an electrical torque return line 15.

This means that the control device 3 has an operation by incrementation in that the fuel flow rate command 9 and the electrical torque command 11 determined in a step k use the fuel flow rate command 9 and the electrical torque command 11 determined in a step k−1, preceding the step k in time.

Returning the fuel flow rate command 9, as indicated by the fuel return line 17, and the electrical torque command 11, as indicated by the electrical torque return line 15, to the control device 3, i.e. the fuel flow rate and electrical torque commands determined in step k, makes it possible to take into account any deviation between the initial command and a saturation.

The control device 3 may comprise, for example, a memory 31 configured to record:
a sequence of speed setpoints of the low-pressure shaft 7, in particular the variation over time of the angular velocity of the low-pressure shaft of the hybrid turbomachine 1,
a sequence of measurements of the speed of the high-pressure shaft 4, in particular the variation over time of the angular velocity of the high-pressure shaft received from the hybrid turbomachine 1, and/or
a sequence of measurements of the speed of the low-pressure shaft 5, in particular the variation over time of the angular velocity of the low-pressure shaft received from the hybrid turbomachine 1.

Moreover, the memory 31 can also record indicators 13 and/or results previously determined in the control device 3, for example in the preceding step k−1.

The terms “sequence of setpoints” or “sequence of measurements” should be understood to mean a time-domain series of successive values of setpoints or measurements. Each value is time-stamped and/or associated with a time, such that a sequence of setpoints or measurements corresponds to a variation over time of a quantity able to be graphically represented.

The control device may also comprise an electronic control unit 33 configured to determine, particularly in real time, the fuel flow rate command 9 and the electrical torque command 11, for example based on the received data, such as for example the measurement of the speed of the high-pressure shaft 4, the measurement of the speed of the low-pressure shaft 5, the measurement of the external pressure 6 and/or the speed setpoint of the low-pressure shaft 7, and/or recorded, such as for example the sequence of engine speed setpoints 7, the sequence of measurements of the speed of the high-pressure shaft 4, the sequence of measurements of the speed of the low-pressure shaft 5 and/or the indicators 13.

The control device 3 shown in FIG. 1 may correspond to an architecture of MISO (Multiple Input Single Output) type, since it supplies two inputs to the hybrid turbomachine 1 as a function of a single output thereof.

### Control Method

The control device 3 according to the invention makes it possible to implement a method for controlling the hybrid turbomachine 1 comprising the following steps.

In a first step, a sequence of speed setpoints of the low-pressure shaft 7, particularly of an angular velocity of the low-pressure shaft of the hybrid turbomachine 1, is recorded. The recording of the first step is done, for example, in the memory 31 of the control device 3. The recording of the sequence of speed setpoints of the low-pressure shaft 7 can take place before a starting of the hybrid turbomachine 1 and/or before any measurement of the engine speed on the hybrid turbomachine 1.

The sequence of speed setpoints of the low-pressure shaft 7 can be written in the form of values NLCₚ, where p is an index varying from 0 to N and represents a position of the value in the sequence.

In a second step, a sequence of measurements of the speed of the high-pressure shaft 4, particularly of the angular velocity of the high-pressure shaft, and a sequence of measurements of the speed of the low-pressure shaft 5, particularly of the angular velocity 5 of the low-pressure shaft, are recorded.

Once the hybrid turbomachine 1 is started, the engine ratings are monitored and successive measurements relating to the high-pressure shaft and to the low-pressure shaft are transmitted to the control device 3, forming two sequences of measurements of the speed of the high-pressure shaft and of the speed of the low-pressure shaft, therefore comprising more and more measurements over time. The recording of the second step is done in the memory 31 of the control device 3.

The sequence of measurements of the speed of the high-pressure shaft 4 can be written in the form of values NHₚ, where p is an index varying from 0 to k and represents a position of the value in the sequence. The index k is the index of the last measurement NHₖ received.

The sequence of measurements of the speed of the low-pressure shaft 5 can be written in the form of values NLₚ, where p is an index varying from 0 to k and represents a position of the value in the sequence. The index k is the index of the last measurement NLₖ received.

The indices correspond to successive time increments or successive operating points of the hybrid turbomachine 1.

In a third step, the electronic control unit 33 determines a sequence of deviations between the measurement of the speed of the low-pressure shaft 5 and the speed setpoint of the low-pressure shaft 7, each deviation being equal to a difference between a measurement of the speed of the low-pressure shaft 5 and a speed setpoint of the low-pressure shaft 7 associated with the measurement of the speed of the low-pressure shaft 5. The sequence of measurements of the speed of the low-pressure shaft 5 and the sequence of speed setpoints of the low-pressure shaft 7 do not necessarily contain the same number of values, but they are referenced in the time domain with respect to one another. In other words, each measurement of the speed of the low-pressure shaft 5 has an associated speed setpoint of the low-pressure shaft 7, the measurement of the speed of the low-pressure shaft 5 and the speed setpoint of the low-pressure shaft 7 coinciding in time. The objective of the regulation is to make each measurement of the speed of the low-pressure shaft 5 as close as possible to its speed setpoint of the low-pressure shaft 7.

The sequence of deviations can be written in the form of values ENLₚ, where p is an index varying from 0 to k, the deviations are computed index by index according to the computation:

$${ENL}_{p} = {NL}_{p} - {NLC}_{p} .$$

In a fourth step, the electronic control unit 33 determines, in particular simultaneously, a variation in fuel flow rate ΔWFₚ equal to a difference in the fuel flow rate command 9 between a time p and a preceding time p−1, i.e.:

$$Δ {WF}_{p} = {WF}_{p} - {WF}_{p - 1}$$

and a variation in electrical torque ΔTRQₚ, corresponding to a difference in the electrical torque command 11 between a time p and a preceding time p−1, i.e.:

$$Δ {TRQ}_{p} = {TRQ}_{p} - {TRQ}_{p - 1} ,$$

intended to be applied to the low-pressure shaft.

The fuel flow rate command 9 and the electrical torque command 11 are time-variant signals and can be discretized in the form of a time-domain sequence of fuel commands WFₚ and a sequence of electrical torque commands TRQₚ.

The values of the time-domain sequence of fuel commands WFₚ and of the sequence of electrical torque commands TRQₚ are indexed by an index p varying from 0 to k, each command being associated with one and the same measurement.

The variation in the fuel flow rate command ΔWFₚ and the variation in the electrical torque command ΔTRQₚ are determined as a function of:
a difference in high-pressure speed between a last measurement and a penultimate measurement of a sequence of measurements of the speed of the high-pressure shaft 4 of the hybrid turbomachine 1,
a difference in low-pressure speed between a last measurement and a penultimate measurement of the sequence of measurements of the speed of the low-pressure shaft 5 of the hybrid turbomachine 1,
a deviation ENLₖ associated with the last measurement of the speed of the low-pressure shaft 5, and
a sum of all the deviations.

The last measurement of the speed of the low-pressure shaft 5 is the last measurement received by the control device 3 and therefore constitutes the most recent measurement of the state of the speed of the low-pressure shaft. This is therefore the measurement NLₖ, which corresponds to the last index k. The difference ΔNLₖ between the last measurement and the penultimate measurement of the sequence of measurements of the speed of the low-pressure shaft 5 is written:

$$Δ {NL}_{k} = {NL}_{k} - {NL}_{k - 1} .$$

The deviation associated with the last measurement of the speed of the low-pressure shaft 5 is written:

$${ENL}_{k} = {NL}_{k} - {NLC}_{k} .$$

The sum of all the deviations IENLₖ is computed using the following expression:

$${IENL}_{k} = {ENL}_{0} + {ENL}_{1} + {ENL}_{2} + … + {ENL}_{k - 1} + {ENL}_{k} .$$

The sum of all the deviations IENLₖ corresponds to an integral of the error from the index p=0 to the last index p=k.

The method that has been described here uses four output quantities in relation to the low-pressure speed and the high-pressure speed (measurement of the angular velocity for each speed and setpoint of the angular velocity for the low-pressure speed): the difference between a last measurement and a penultimate measurement for each speed, the deviation associated with the last measurement for the low-pressure speed, and the sum of all the deviations for the low-pressure speed. These four quantities make it possible to determine the input quantities without the use of any output quantity other than an angular velocity, or an output quantity, the setpoint curve or real-time measurement of which would be difficult to determine or implement. Moreover, when the determination of the values of the two input quantities is done simultaneously, the two degrees of freedom of the turbomachine are used more optimally than in the prior art.

Such a determination is based on a particular modeling of the hybrid turbomachine 1 by a system of Linear Time-Invariant (LTI) type, in which, to go from the index k to the index k+1, the engine speed is given by a first equation, or equation 1

$$[ \begin{matrix}Δ {NH}_{k + 1} \\ Δ {NL}_{k + 1}\end{matrix} ] = A \times [ \begin{matrix}Δ {NH}_{k} \\ Δ {NL}_{k}\end{matrix} ] + B \times [ \begin{matrix}Δ {WF}_{k} \\ Δ {TRQ}_{k}\end{matrix} ] \qquad ( eq . 1 )$$

The equation (1) is a synthesis model. It constitutes a mathematical description of the system making it possible to relate the inputs, namely the fuel flow rate command 9, the fuel flow rate setpoint, the electrical torque command 11 of the low-pressure shaft or the electrical torque setpoint of the low-pressure shaft, and the output, namely the speed of the low-pressure shaft and/or the speed of the high-pressure shaft.

The term A of the equation (1) is a state matrix, particularly a matrix 2*2, the to-left and bottom-right diagonal terms of which are related to the inertia of the hybrid turbomachine 1.

The term B of the equation (1) is a control matrix, particularly a 2*2 matrix able to contain an item of information of a gain of the system, particularly a static gain establishing a relationship between a setpoint increment (fuel flow rate and/or electrical torque) and a speed increment (speed of the low-pressure shaft and/or speed of the high-pressure shaft) obtained by this setpoint increment once the speed has stabilized.

To cancel out a dynamic error, also known as lag, consisting in a delay between a linear variation of the setpoint and the corresponding variation of the speed, provision is made for using an “augmented” synthesis model.

For this purpose, the “augmented” synthesis model uses, in addition to the difference ΔNHₖ between the last measurement and the penultimate measurement of the sequence of measurements of the speed of the high-pressure shaft 4 and the difference ΔNLₖ between the last measurement and the penultimate measurement of the sequence of measurements of the speed of the low-pressure shaft 5:
the deviation ENLₖ associated with the last measurement of the speed of the low-pressure shaft 5, corresponding in particular to a slaving error, and
the sum of all the deviations IENLₖ, corresponding in particular to the integral of the slaving error,
   according to a second equation or equation (2), more general than the first equation, or equation (1):

$$[ \text{} \begin{matrix}Δ {NH}_{k + 1} \\ Δ {NL}_{k + 1} \\ {ENL}_{k + 1} \\ {IENL}_{k + 1}\end{matrix} ] = [ \begin{matrix}A & & 0 & 0 \\ 0 & - 1 & 1 & 0 \\ 0 & - 1 & 1 & 1\end{matrix} ] [ \text{} \begin{matrix}Δ {NH}_{k} \\ Δ {NL}_{k} \\ {ENL}_{k} \\ {IENL}_{k}\end{matrix} ] + [ \begin{matrix}B \\ 0 \\ 0\end{matrix} ] [ \begin{matrix}Δ {WF}_{k} \\ Δ {TRQ}_{k}\end{matrix} ] + [ \begin{matrix}0 \\ 0 \\ 1 \\ 1\end{matrix} ] Δ {NLC}_{k} \qquad ( eq . 2 )$$

The term ΔNLCₖ corresponds to the difference between the last setpoint of rank k and the penultimate setpoint of rank k−1 and is written:

$$Δ {NLC}_{k} = {NLC}_{k} - {NLC}_{k - 1} .$$

The equation (2) can be used to determine a third equation, or equation (3), expressing the variation in fuel flow rate ΔWFₖ and the variation in electrical torque ΔTRQₖ as a function of:
the difference ΔNHₖ between the last measurement and the penultimate measurement of the sequence of measurements of the speed of the high-pressure shaft 4,
the difference ΔNLₖ between the last measurement and the penultimate measurement of the sequence of measurements of the speed of the low-pressure shaft 5,
the deviation ENLₖ associated with the last measurement of the speed of the low-pressure shaft 5, and
the sum of all the deviations IENLₖ
   in the form of a third equation, or equation (3):

$$[ \begin{matrix}Δ {WF}_{k} \\ Δ {TRQ}_{k}\end{matrix} ] = - K [ \begin{matrix}Δ {NH}_{k} \\ Δ {NL}_{k} \\ {ENH}_{k} \\ {IENH}_{k}\end{matrix} ] \qquad ( eq . 3 )$$

in which the term “K” is a gain matrix.

The variation in fuel flow rate ΔWFₖ and the variation in electrical torque ΔTRQₖ are obtained, in particular simultaneously, by the production of the gain matrix K and of a vector formed of
the difference ΔNHₖ between the last measurement and the penultimate measurement of the speed of the high-pressure shaft 4,
the difference ΔNLₖ between the last measurement and the penultimate measurement of the speed of the low-pressure shaft 5,
the deviation ENLₖ associated with the last measurement of the speed of the low-pressure shaft 5, and
the sum IENLₖ of all the deviations.

To use a corrector, it is necessary beforehand to determine the gain matrix K, which equates to performing “a synthesis of the multivariable corrector”.

Such a synthesis is of “linear quadratic state feedback” type and consists in minimizing a criterion or a quantity ‘J’ in which weighting matrices Q, R and S appear.

These are set at the start of the computation according to the desired behavior of the engine, and, in particular, according to the desired absence of lag.

More precisely, it is the choice of the weighting matrices Q, R and S which makes it possible to obtain different settings of the corrector and the desired engine behavior, for example the elimination of the lag, i.e. a minimization of the transfer between the setpoint and the slaving error within the meaning of the standard 2 by constraining the dynamic of the error.

$$J = {\sum }_{k = 0}^{∞} ( [ Δ {NH}_{k} Δ {NL}_{k} {ENL}_{k} {IENL}_{k} ] \times Q \times [ \begin{matrix}Δ {NH}_{k} \\ Δ {NL}_{k} \\ {ENL}_{k} \\ {IENL}_{k}\end{matrix} ] + [ Δ {WF}_{k} Δ {TRQ}_{k} ] \times R \times [ \text{} \begin{matrix}Δ {WF}_{k} \\ Δ {TRQ}_{k}\end{matrix} ] + 2 [ Δ {NH}_{k} Δ {NL}_{k} {ENL}_{k} {IENL}_{k} ] \times S \times [ \begin{matrix}Δ {WF}_{k} \\ Δ {TRQ}_{k}\end{matrix} ] )$$

In the proposed example, the matrix Q can be a 4*4 matrix, the matrix R can be a 2*2 matrix and the matrix S can be a 4*2 matrix.

The minimization of the criterion j by the Lagrangian makes it possible to work with an analytic expression of the gain matrix K in the form:

$$K = {( R + {B}^{T} PB )}^{- 1} ( {B}^{T} PA + S )$$

where the terms R, B, A and S are known matrices. Only the matrix P remains to be determined according to the expression of the single solution of the discrete Riccati algebraic equation:

$${\tilde{A}}^{T} P \tilde{A} - P - ( {\tilde{A}}^{T} P + S ) {( {\tilde{B}}^{T} P \tilde{B} + R )}^{- 1} ( {\tilde{B}}^{T} P \tilde{A} + {S}^{T} ) + Q = 0$$

with:

$$\tilde{A} = [ \begin{matrix}A & & 0 & 0 \\ 0 & - 1 & 1 & 0 \\ 0 & - 1 & 1 & 1\end{matrix} ] and \tilde{B} = [ \begin{matrix}B \\ 0 \\ 0\end{matrix} ]$$

This last equation makes it possible to determine the matrix P and, consequently, the gain matrix K.

Knowing the gain matrix K makes it possible, during the control method, to determine, in particular simultaneously, the variation in fuel flow rate ΔWFₖ and the variation in electrical torque ΔTRQₖ as a function of the difference ΔNHk between the last measurement and the penultimate measurement of the speed of the high-pressure shaft 4, the deviation ENLₖ associated with the last measurement of the speed of the low-pressure shaft 5, and the sum IENLₖ of all the deviations, using the third equation, or equation (3):

$$[ \begin{matrix}Δ {WF}_{k} \\ Δ {TRQ}_{k}\end{matrix} ] = - K [ \begin{matrix}Δ {NH}_{k} \\ Δ {NL}_{k} \\ {ENL}_{k} \\ IEN {L}_{k}\end{matrix} ] \qquad ( eq . 3 )$$

Note that the gain matrix K depends on the engine operating point. More precisely, the gain matrix K is determined based on the matrices A and B depending on the engine operating point.

This is taken into account in practice by previously determining a set of reference matrices and, as a function of the measurement of the engine operating point, computing the gain matrix by interpolation between two reference matrices.

The set of reference matrices is determined beforehand, before the implementation of the control method. Each reference matrix is associated with an operating point of the hybrid turbomachine 1, the so-called reference point.

A reference matrix is associated with an equation of change of a vector tracking a speed or angular velocity command formed of a variation in speed or angular velocity at an instant in time, a difference in speed or angular velocity at the command at that time and an integral of the difference.

The operating point can in particular be deduced from an internal measurement of the engine, for example a measurement of the speed or of the angular velocity of the engine shaft or a measurement of an input pressure of the combustion chamber, and of a measurement external to the engine, for example the external pressure. The operating point can therefore be associated with a vector of several measurements.

The measured operating point, more specifically an “operating point” vector, makes it possible to determine the gain matrix K to be used at this point by linear interpolation between reference matrices associated with reference vectors which surrounds the “operating point” vector.

The taking into account of the fuel saturation, i.e. the impossibility of increasing a fuel setpoint beyond a certain maximum, also known as “saturated control”, and/or of the torque, i.e. the impossibility of increasing the setpoint of the electrical torque because of a machine limit or a limit of a level of hybridization, can be managed by an “augmentation” of the model.

For example, the state vector comprising
the difference ΔNHk between the last measurement and the penultimate measurement of the speed of the high-pressure shaft 4,
the difference ΔNLk between the last measurement and the penultimate measurement of the speed of the low-pressure shaft 5,
the deviation ENLₖ associated with the last measurement of the speed of the low-pressure shaft 5, corresponding in particular to the slaving error, and
the sum IENLₖ of all the deviations, corresponding in particular to the integral of the slaving error, can be completed by a deviation between the saturated command and the command computed by the trajectory tracking corrector.

Different ways to take into account such a state vector may be envisioned, particularly by considering it as a perturbation and/or using the mathematical tools described previously.

In the same way, one may take into account:
the saturation of the electrical torque of the low-pressure shaft, i.e. the impossibility of increasing the setpoint of the electrical torque of the low-pressure shaft because of a machine limit or a limit of a level of hybridization, and/or
the saturation of the electrical torque of the high-pressure shaft, i.e. the impossibility of increasing the setpoint of the electrical torque of the high-pressure shaft because of a machine limit or a limit of a level of hybridization.

The fuel flow rate setpoint 9 and the torque setpoint 11 are computed by numerical integration according to the following equations:

$$\{ \begin{matrix}{WF}_{k} = Δ {WF}_{k} + {WF}_{k - 1} \\ {TRQ}_{k} = Δ {TRQ}_{k} + {TRQ}_{k - 1}\end{matrix}$$

### Results

FIG. 2 is a schematic representation of acceleration control tracking according to the invention and shows the results of numerical simulations of control tracking according to the control method previously described.

FIG. 2 therefore relates to an acceleration of the engine speed.

FIG. 2 comprises a first graph 2A in which the ordinate axis corresponds to the speed, or angular velocity, of the low-pressure shaft and the abscissa axis corresponds to the time.

The first graph 2A of FIG. 2 includes:
a setpoint curve 20, corresponding to the speed setpoint of the low-pressure shaft 7,
a speed curve 22, corresponding to the measurement of the speed of the low-pressure shaft 5, and
a speed request curve 24, corresponding to a speed request by the pilot. Moreover, the FIG. 2 comprises a second graph 2B wherein the ordinate axis corresponds to a fuel flow rate and the abscissa axis corresponds to the time.

The second graph 2B of FIG. 2 includes:
a maximum fuel flow rate curve 30, corresponding to a maximum fuel flow rate which is not to be exceeded for the current engine speed,
a minimum fuel flow rate curve 34, corresponding to a minimum fuel flow rate below which it is not possible to drop, and
a fuel command curve 32, corresponding to the fuel flow rate command 9.

In addition, the FIG. 2 comprises a third graph 2C wherein the ordinate axis corresponds to an electrical torque intended to be applied to the low-pressure shaft and the abscissa axis corresponds to time.

The third graph 2C of FIG. 2 includes:
an electrical torque command curve 40, corresponding to the electrical torque command 11, and
a minimum electrical torque curve 42, corresponding to a minimum electrical torque below which it is not possible to drop.

The first graph 2A, the second graph 2B and the third graph 2C of FIG. 2 are synchronized, such that, at each time, the different graphs give the setpoint, measurement and/or command values corresponding to the operating point of the hybrid turbomachine 1.

The fuel flow rate command 9 and the electrical torque command 11 are generated in real time by the control method described previously.

In FIG. 2, the sequences of setpoints, measurements and commands contain enough plotting points on the figures for each one to be comparable to a continuous curve.

One first notes that the fuel flow rate command 9 and the electrical torque command 11 vary independently. In particular, the electrical torque command 11 can be different from zero, without the fuel flow rate command 9 being in saturation, i.e. colinear with the maximum fuel flow rate curve 6 or the minimum fuel flow rate curve 64.

For example, the fuel flow rate command curve 32 in FIG. 2 is never in saturation whereas the electrical torque command curve 40 varies and takes values different from zero.

More precisely, when the pilot asks the engine to accelerate using a request to idle at full throttle, as represented by the speed request curve 24, as soon as the transient regulation indicator, also known as TopAcc, is activated, the regulation implemented by the control method manifests first as an increase in the fuel, as represented by the fuel command curve 32, then an increase in the electrical torque of the low-pressure shaft, as represented by the electrical torque command curve 4, to cancel out the dynamic error after 3 seconds. The fuel command is then not saturated by its maximum limit (curve 30). As soon as the transient regulation indicator, also referred to as Top Acc, is lowered, the single-variable loop N1stab only takes control of the fuel to regulate the speed NL to the setpoint NL_dmd from the PWM and the torque BP is reset to zero.

When the generation of the two commands is simultaneous, it makes it possible to explore operating ratings of the hybrid turbomachine 1 which are broader than in the prior art and to have a better optimization of operation.

Moreover, the lag error in the illustrated result is small. A lag error corresponds to a time shift between the setpoint and the output quantity measurement.

There is a lag, for example, when the measured speed or angular velocity 22 is delayed with respect to the speed or to the setpoint angular velocity 20.

The speed curve 22 has a small or no time-shift in relation to the setpoint curve 20, so that the lag is small.

Such a benefit stems in particular from the fact that the control method is equivalent to an architecture of “state feedback” type of class 2 (i.e. comprising 2 integrators, or two integrated quantities, namely the deviation ENLₖ associated with the last measurement of the speed of the low-pressure shaft 5 and the sum IENLₖ of all the deviations, to compute, in particular simultaneously, the fuel flow rate setpoint 9 and the electrical torque setpoint 11.

The fuel flow rate setpoint 9 and the electrical torque setpoint 11 make it possible to track the acceleration and/or deceleration trajectory of the engine speed without lag when the trajectory tracking loop is activated and applied.

Specifically, according to the flight phase, the setpoint obtained by the electronic control unit, as described until now, can be used or not. According to the flight phase, the requirement for a small lag error is not always present. This is in particular the case for a “cruise” flight phase in which there are few rapid transients and where one will tend to use a more suitable corrector.

Although the corrector of “state feedback” type of class 2 is not always applied, it is always active, in the sense that it constantly computes a setpoint. This in particular allows a continuity of the setpoint when switching from one electronic control unit to another.

The control method and the control device 3 described here make it possible to meet the pilot requirement by taking into account the capacity of the engine to accelerate or decelerate, and in particular to:
limit the acceleration time of the “OK” engines having a surge margin in order to reduce oversupplies of fuel to the combustion chamber, also known as over-fueling, and thus limit an Exhaust Gas Temperature (or EGT), during accelerations to increase the lifetime; and
limit asymmetry of thrust between the engines during acceleration to reduce the drag of the airplane and the engine yaw effect.

The control method then provides a closed-loop regulation solution making it possible to meet the requisite transient time without the engine being restricted by its operability limits.

The main advantage of controlling the speed of the low-pressure shaft is of controlling a better image of the thrust for hybrid turbomachine architectures 1 with a high bypass ratio (or BPR).

The proposed solution is relatively simple from a theoretical point of view, and from the point of view of adjustment and implementation.

1. A method for controlling a hybrid turbomachine, the method comprising:
determining a sequence of deviations, each deviation being a difference between a measurement of a sequence of measurements of a speed of a low-pressure shaft of the hybrid turbomachine and a setpoint of a sequence of setpoints of the speed of the low-pressure shaft,
determining a variation of fuel flow rate and determining a variation of electrical torque, the electrical torque being configured to be applied to the low-pressure shaft, wherein determining the variation of fuel flow rate and determining the variation of electrical torque both comprise using a difference in high-pressure speed between a last measurement and a penultimate measurement of a sequence of measurements of a speed of a high-pressure shaft of the hybrid turbomachine, a difference in low-pressure speed between a last measurement and a penultimate measurement of the sequence of measurements of the speed of the low-pressure shaft, a last deviation of the sequence of deviations, the last deviation being temporally associated with the last measurement of the speed of the low-pressure shaft, and a sum of the deviations of the sequence of deviations; and
controlling the hybrid turbomachine in order to vary a fuel flow rate according to the determined variation of fuel flow rate and in order to vary an electrical torque according to the determined variation of electrical torque.

2. The method for controlling a hybrid turbomachine as claimed in claim 1, wherein determining the variation of fuel flow rate and determining the variation of electrical torque both comprise determining a product of a gain matrix and a vector, the vector being formed of the difference in high-pressure speed, the difference in low-pressure speed, the last deviation of the sequence of deviations and the sum of the deviations of the sequence of deviations.

3. The method for controlling a hybrid turbomachine as claimed in claim 2, comprising determining the gain matrix by interpolation between two reference matrices of a set of reference matrices such as to take into account an operating point of the hybrid turbomachine associated with the last measurement.

4. A control device for controlling a hybrid turbomachine, the device comprising:
an input configured to receive a sequence of measurements of the speed of a low-pressure shaft of the hybrid turbomachine and a sequence of measurements of the speed of a high-pressure shaft of the hybrid turbomachine,
a memory configured to record the sequence of measurements of the speed of the low-pressure shaft, the sequence of measurements of the speed of the high-pressure shaft (4) and a sequence of setpoints of the speed of the low-pressure shaft,
an electronic controller configured to determine a sequence of deviations, each deviation being a difference between a measurement of the sequence of measurements of the speed of the low-pressure shaft, and a setpoint of the sequence of setpoints of the speed of the low-pressure shaft, the electronic controller being configured to determine a variation of fuel flow rate and a variation of electrical torque, the electrical torque being configured to be applied to the low-pressure shaft, the electronic controller being configured, in order to determine the variation of fuel flow rate and the variation of electrical torque, the to use a difference in high-pressure speed between a last measurement and a penultimate measurement of the sequence of measurements of the speed of the high-pressure shaft, a difference in low-pressure speed between a last measurement and a penultimate measurement of a sequence of measurements of the speed of the low-pressure shaft, a last deviation of the sequence of deviations, the last deviation being temporally associated with the last measurement of the speed of the low-pressure shaft, and a sum of the deviations of the sequence of deviations; and
an output configured to supply a command to the hybrid turbomachine.

5. A hybrid turbomachine comprising the control device as claimed in claim 4.

6. An aircraft comprising the hybrid turbomachine as claimed in claim 5.

7. The method for controlling a hybrid turbine engine according to claim 1, wherein determining the variation of fuel flow rate is simultaneous with determining the variation of electrical torque.

8. The control device according to claim 4, wherein the electronic controller is configured to determine the variation of fuel flow rate simultaneously with the variation of electrical torque.
